(19) United States
(12) Patent Application Publication
(10) Pub. No.: US 2006/0243150 A1
(43) Pub. Date: Nov. 2, 2006

(54) Instrumented belt tensioner roller device and associated monitoring method

(76) Inventor: Franck Landrieve, Fondettes (FR)

Correspondence Address: ERIC B. MEYERTONS;MEYERTONS, HOOD, KIVLIN, KOWERT & GOETZEL, P.C., P.O. BOX 398, AUSTIN, TX, 78767-0398, US

(21) Appl. No.: 11/361,306

(22) Filed: Feb. 24, 2006

(30) Foreign Application Priority Data
Feb. 28, 2005 (FR) 0502005

(51) Int. Cl. G03G 15/32

(52) U.S. Cl. 101/494

(57) ABSTRACT

The belt tensioner roller device is provided with a fixed support able to hold the device on an engine block, with moving parts that can move with respect to the fixed support, with a rotary roller supported by the moving parts and intended to be in contact with the belt, and with a component able to exert a permanent force between the fixed support and the moving parts. The rotary roller comprises a target element, and the fixed support comprises at least one sensor element mounted facing the target element of the roller with a gap and collaborating with the said target element to detect belt wear as a function of displacement of the rotary roller with respect to the fixed support.

### BACKGROUND OF THE INVENTION

1. Field of the Invention

The present invention relates to the field of automatic belt tensioner roller devices, particularly those used to ensure adequate belt tension, for example for motor vehicle internal combustion engine timing belts.

2. Description of the Relevant Art

A belt tensioner roller device generally comprises a support intended to be fixed to the engine block and a moving part able to move angularly relative to the support. The said moving part is provided with an eccentric and with a rolling bearing on which there is mounted a roller intended to be brought into contact with the belt. A spring exerts a permanent tensile force between the support and the moving part, causing the roller to be brought into contact with the belt, with suitable belt tension. The moving part is mounted on the support with a possibility of adjustment so that the belt tension force can be adjusted. For fuller details, reference may be made to documents FR-A-2 744 506 and FR-A-2 668 567.

The tensioner roller device thus allows the belt to be kept under the required tension within a certain tolerance range in spite of the dimensional variations in the belt that may be caused by wear or by temperature variations.

Belt failure, particularly the failure of a motor vehicle combustion engine-timing belt, can cause serious damage to the said engine, and thus adversely affect its dependability.

To this end, document U.S. Pat. No. 6,666,784 discloses a belt tensioner roller device provided with a fixed support mounted on an engine block, an eccentric that can move angularly relative to the said support, and a damping element positioned at the fixed support. Mounted inside the damping element is a belt wear detection device equipped with at least one magnet fixed to a moving element of the damping element and with a sensor able to detect the linear position of the moving element, the said linear position being associated with the angular position of the eccentric relative to the fixed support.

The device has the disadvantage of having a relatively high number of intermediate components involved in the drive line between the moving element and the belt, and this can give rise to a certain degree of inaccuracy in the measurements made.

The Applicant Company has also developed a belt tensioner roller device, filed as French Patent Application No. 01 14 669. The tensioner roller device is provided with a fixed support, with a working eccentric able to move angularly relative to the fixed support, with an encoder element mounted on the eccentric and having a multipolar encoding ring, with a sensor element mounted on the fixed support and able to collaborate with the said encoder element to measure the angular displacement of the working eccentric and with a signal processing module for processing the signals emitted by the sensor element and able to determine information regarding belt wear.

Such a tensioning roller device, although being particularly precise and effective in detecting angular oscillations and displacements of the eccentric relative to the fixed support, has the disadvantage of having detection elements that are too expensive for simply measuring belt wear thresholds, and which may be incompatible with mass production of tensioning roller devices.

Furthermore, this device cannot be fitted to a tensioning roller the displacement of which is in a straight line and does not employ an eccentric.

### SUMMARY OF THE INVENTION

In an embodiment, these disadvantages may be remedied by a belt tensioner roller device able to detect the tension in a belt in order therefrom to deduce a predetermined wear limit in a way that is particularly simple, precise, reliable and economical.

To this end, the belt tensioner roller device is provided with a fixed support able to hold the device on an engine block, with moving parts that can move with respect to the fixed support, with a roller supported by the moving parts and intended to be in contact with the belt, and with a component able to exert a permanent force between the fixed support and the moving parts.

According to embodiment, the rotary roller includes a target element and the fixed support includes at least one sensor element mounted facing the target element of the roller with a gap and collaborating magnetically with the said target element to detect belt wear as a function of displacement of the rotary roller with respect to the fixed support.

Such a device has the advantage of allowing belt wear to be detected directly from a displacement of the rotating part of the tensioner roller device which is in contact with the belt and maintains the tension therein.

In other words, the arrangement of a target element directly on the rotary roller allows particularly precise and reliable measurements to be taken, belt wear being associated directly with the belt-induced displacement of the rotary roller relative to the fixed support.

Furthermore, arranging the sensor element at the fixed support not only makes it easier to fit the device but also, in the event of sensor element failure, makes the intervention needed simpler by not requiring any operation in the region of the moving parts.

As a preference, the fixed support further includes at least one magnetic element able to create a magnetic field near the sensor element, the said magnetic element collaborating with the target element of the roller to modify the value of the magnetic field as a function of the displacement of the roller relative to the fixed support.

Combining a sensor element with a magnetic element able to create a magnetic field near the said sensor element in order to detect belt wear makes it possible to obtain particularly precise measurements and to do so economically.

Advantageously, the gap can vary as a function of the displacement of the roller relative to the fixed support. The gap may be radial or axial.

In one embodiment, the fixed support includes two sensor elements positioned radially on either side of the target element of the roller, the sensor elements being electrically connected in such a way as to take a differential measurement of the signals supplied by the sensor elements.

An instrumented tensioner roller device such as this makes it possible to achieve particularly reliable detection of the degree of belt wear while at the same time in particular circumventing the effects of possible dimensional variations due to thermal variations, variations in the properties of the target element or variations in the voltage powering the sensor elements.

Advantageously, the sensor element detects belt wear as a function of a radial linear displacement of the moving parts with respect to the fixed support.

With preference, the moving parts include a working eccentric that can move angularly relative to the fixed support and supports the roller, the sensor element detecting belt wear as a function of the position of the roller relative to the fixed support.

The fixed support may include a plate on which the sensor element is mounted.

As a preference, the target element includes a ferromagnetic material.

Advantageously, an end portion of the rotary roller forms the target element. An arrangement such as this makes it possible to obtain an instrumented tensioner roller device that is particularly compact in the axial direction. Furthermore, since a portion of the roller forms the target element, there is no need to provide an additional element which would lead to additional cost in order to measure the belt tension.

The target element may be attached to or integral with the working eccentric.

In one embodiment, the target element includes a synthetic material filled with magnetized ferrite powder.

Advantageously, the device includes a sensor unit, mounted on the fixed support, and in which the magnetic element is embedded and the sensor element is at least partially housed.

Arranging the magnetic element such that it is embedded within the sensor unit makes it possible to avoid any possible ingress of elements from outside, for example metallic ones, near its external surface and that could vary the field emitted. The belt tension detection is thus particularly precise.

The sensor element may include a linear or digital magnetosensitive cell. The use of such a sensor element makes it possible to obtain a device of a particularly simple and economical design.

Furthermore, the use of a magnetosensitive cell by comparison with so-called “incremental” sensors allows for highly reliable measurements. This is because incremental sensors have the disadvantage of not being able to detect the true position of one element relative to another fixed element when an associated electronic memory is no longer electrically powered.

The invention also relates to a method for monitoring belt wear, including the steps during which a permanent tensile force is exerted between a fixed support and moving parts that can move with respect to the fixed support and that are in contact with the belt, characterized in that belt wear is detected directly as a function of displacement of the roller relative to the fixed support. The displacement is detected through collaboration of sensor and target elements mounted facing one another with a gap between them, the said displacement being linear and a function of the position of the roller relative to the fixed support.

### BRIEF DESCRIPTION OF THE DRAWINGS

The present invention will be better understood upon reading the detailed description of some embodiments taken by way of entirely non-limiting examples and illustrated by the attached drawings, in which:

FIG. 1 is a view in axial section of a belt tensioner roller device according to a first embodiment;

FIG. 2 is a detailed view of the device of FIG. 1;

FIG. 3 is a view in axial section of a tensioner roller device according to a second embodiment;

FIG. 4 is a schematic view of a processing unit for sensor elements of the device of FIG. 3;

FIG. 5 is a view in axial section of a tensioner roller device according to a third embodiment;

FIG. 6 is a view in axial section of a tensioner roller device according to a fourth embodiment;

FIG. 7 is a view in axial section of a tensioner roller device according to a fifth embodiment.

While the invention is susceptible to various modifications and alternative forms, specific embodiments thereof are shown by way of example in the drawings and will herein be described in detail. It should be understood, however, that the drawing and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

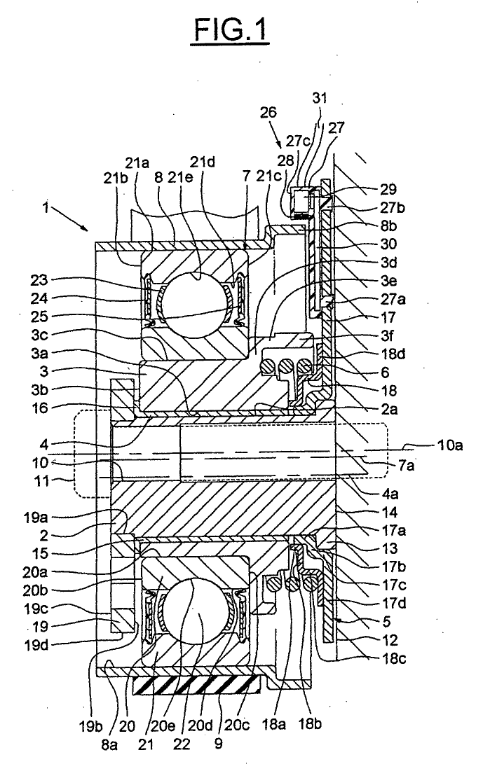

As can be seen in FIG. 1, the tensioner roller device, referenced 1 in its entirety, includes fixed parts provided with an adjusting eccentric 2, and moving parts mounted pivotably on the fixed parts and provided with a working eccentric 3. A bearing brass forming a plain bearing 4 is mounted rigidly by clamping in the working eccentric 3. An actuator including a spring 6 is mounted between the said working eccentric 3 and a fixed support 5 including the adjusting eccentric 2, a roller or pulley 8 being rotationally mounted on the working eccentric via a rolling bearing 7, the said roller 8 resting against a belt 9.

The adjusting eccentric 2, of cylindrical overall shape, includes a bore 10 of axis 10a offset towards the outside relative to the geometric axis of the said eccentric. The bore 10 allows the passage of a fastener such as a screw 11, depicted in dotted line, for fastening the said adjusting eccentric 2 to an engine block 12. The adjusting eccentric 2 can thus pivot angularly relative to the engine block 2 when the screw 11 is slackened, tightening the said screw 111 immobilizing the adjusting eccentric 2 on the said block. The adjusting eccentric 2 includes, at one axial end, a radially outwardly directed radial flange 13. The flange 13 more or less radially extends a radial bearing surface 14 via which the adjusting eccentric 2 bears against the engine block 12 so as to increase the area over which the said adjusting eccentric 2 bears against the engine block 12.

The plain bearing 4, of axis 4a, is in the form of an annular bushing including an axial portion 15, tightly push-fitted into a bore 3a of the working eccentric 3, and able to slide over the exterior cylindrical surface 2a of the adjusting eccentric 2. The axial portion 15 is extended, at one axial end, the opposite end to the flange 13, by an outwardly directed radial portion 16. The radial portion 16 bears against a radial transverse surface of the working eccentric 3.

The fixed support 5 also includes a base plate 17 equipped with an axial guide portion 17a of tubular shape, here exhibiting a short axial dimension and defining a bore that comes into contact with the exterior surface 2a of the adjusting eccentric 2. The axial portion 17a is extended outwards, from one axial end, the same end as the flange 13, by a radial portion 17b bearing against the said flange 13. The radial portion 17b is axially extended, from a larger-diameter region at the opposite end to the axial portion 17a, by an axial portion 17c which extends radially outwards from its free end in the form of a radial portion 17d situated axially substantially level with the flange 13. The radial portion 17d extends radially outwards, one end being situated radially between the adjusting eccentric 2 and the roller 8, an opposite end being radially offset outwards relative to the said roller 8. The base plate 17 is immobilized with respect to the engine block 12, for example using a pin fixed to the engine block 12 and projecting through a space formed in the thickness of the base plate 17. Advantageously, the base plate 17 is made by cutting, pressing and folding, from a thin sheet steel blank.

The support 5 also includes an intermediate plate 18 more or less matching the shape of the base plate 17. The intermediate plate 18 is fitted axially into and centered on the said base plate 17, on the same side as the adjusting eccentric 2. The intermediate plate 18, advantageously made of steel sheet, includes an axial portion 18a, of tubular shape, defining a bore that comes into contact with the exterior surface of the axial portion 17a of the base plate 17. The axial portion 18a is extended outwards, from one axial end, by a radial portion 18b which extends from a larger-diameter region, on the opposite side to the axial portion 18a, in the form of an axial portion 18c. The axial portion 18c is extended from its free end by a radial portion 18d in contact with the radial portion 17d of the base plate 17. The axial portions 18a, 18c and the radial portions 18b, 18d of the intermediate plate 18 are formed as one piece.

The working eccentric 3 includes a radial surface 3b positioned axially away from the base plate 17, a cylindrical exterior surface 3c extending over most of its length from the transverse radial surface 3b, a radial portion 3d extending outwards from the end of the cylindrical exterior surface 3c and an axial portion 3e extending from the free end of the radial portion 3d axially away from the transverse radial surface 3b. The working eccentric 3 is locally extended, in the region of the axial portion 3e, by an axial extension 3f extending axially towards the base plate 17. The axial extension 3f here has axial and radial dimensions markedly greater than those of the axial portion 3e. The axial extension 3f may, for example, extend angularly over between 30 and 40°.

The radial surface 3b, the radial portion 3d, the axial portion 3e and the axial extension 3f of the eccentric 3 are formed as one piece.

The radial portion 3d, the axial portion 3e and the radial portion 18d of the intermediate plate 18 define a housing in which the spring 6 is positioned. One end of the spring 6 is hooked over the base plate 17, the other end being secured to the working eccentric 3. Thus, the working eccentric 3 can rotate about the axis 4a relative to the adjusting eccentric 2, while at the same time being subjected to a return torque exerted by the said spring 6.

An axial stop in the form of a ring 19 includes an interior surface 19a mounted, for example, by crimping on a cylindrical exterior surface 2a of the adjusting eccentric 2, at one axial end the opposite side to the flange 13, delimited by two radial surfaces 19b and 19c, and a cylindrical exterior surface 19d. The radial surface 19b forms an axial stop surface for the adjusting eccentric 2 resting against the said surface 19b, via the axial portion 16 of the bearing 4. The surfaces 19a and 2a exhibit complementing shapes and are able to provide an angular connection between the ring 19 and the adjusting eccentric 2. The ring 19 can thus allow the adjusting eccentric 2 to be angularly adjusted before the screw 11 is tightened.

The deep-groove rolling bearing 7 of axis 7a, is inexpensive to manufacture and includes an inner ring 20, an outer ring 21, between which a row of rolling elements 22, here produced in the form of balls, are housed together with a cage 23 that maintains the circumferential spacing of the rolling elements 22 and two seals 24 and 25.

The inner ring 20 is of the solid type. The expression “ring of the solid type” is to be understood to mean a ring the shape of which is obtained by machining with the removal of chips (turning, grinding) from tubes, bar stock, forged and/or rolled blanks. The inner ring 20 includes a bore 20a of cylindrical shape, in contact with the exterior surface 3c of the adjusting eccentric 3 and delimited by two opposed radial lateral surfaces 20b and 20c, the radial surface 20c being in contact with the radial portion 3d, and an exterior cylindrical surface 20d from which is formed a circular groove 20e exhibiting, in cross section, a concave internal profile able to form a raceway for the rolling elements 22, the said groove facing outwards.

The outer ring 21, also of the solid type, includes an exterior cylindrical surface 21a delimited by transverse surfaces 21b and 21c and a bore 21d of cylindrical shape from which there is formed a circular groove 21e which, in cross section, exhibits a concave internal profile able to form a raceway for the rolling elements 22, directed inwards. The bore 21d here includes two annular grooves (not referenced) which are mutually symmetric relative to a plane passing through the centre of the rolling elements 22. Mounted inside the said annular grooves are the seals 24 and 25, which sit close to portions of the cylindrical exterior surface 20d of the inner ring 20 forming narrow passages. The seals 24, 25 are positioned radially between the inner and outer rings 20, 21. The seal 24 is mounted axially between the rolling elements 22 and the radial surfaces 20b and 21b of the rings 20 and 21, the seal 25 being mounted axially between the rolling elements 21 and the radial surfaces 20c, 21c of the said rings.

The roller 8 includes a stepped bore 8a push-fitted onto the exterior cylindrical surface 21a of the outer ring 21 of the rolling bearing 7. The rolling bearing 7 thus gives the roller 8 the freedom to rotate relative to the working eccentric 3 and reacts the radial forces.

The device 1 also includes a sensor unit 26 provided with a support 27 fixed at the level of the base plate 17 of the fixed support 5, axially on the same side as the roller 8, by fixing studs 27a, 27b. The fixing stud 27a is situated radially between the working eccentric 3 and the roller 8, near the said eccentric 3. The fixing stud 27b is radially offset outwards relative to the roller 8. The studs 27a, 27b are each situated near a radial end of the support 27. The support 27 also includes an axial extension 27c extending axially towards the belt 9 so as to be mounted with a small radial gap with respect to the roller 8. The fixing studs 27a, 27b and the extension 27c are made as one piece with the support 27, for example made of synthetic material.

The sensor unit 26 also includes a sensor element 28 and a magnetic element 29 which are respectively mounted semi-embedded and embedded within the extension 27c of the support 27. The sensor element 28, for example a magnetosensitive cell, lies flush with a small-diameter cylindrical surface of the extension 27c of the support 27 so as to be mounted facing an axial end of the roller 8, on the outside. The sensor element 28 is thus mounted with a small radial gap to the roller 8, encouraging the compactness of the device 1.

The magnetic element 29 may, for example, include a permanent magnet provided with two magnetic poles of opposed polarities, “north” and “south”, running axially inside the support 27 so that one of the poles faces towards the sensor element 28, the other pole facing outwards. The magnetic element 29 is axially aligned with the sensor element 28 and radially offset outwards relative to the said sensor element while being mounted a short radial distance therefrom so as to further improve the compactness of the device 1. The magnetic element 29 is able to create a magnetic field which is detected by the sensor element 28, it being possible for the said field to be modified according to the position of the roller 8 relative to the sensor unit 26.

The sensor unit 26 is also provided with a printed circuit board 30 embedded within the support 27 and positioned near the fixing studs 27a, 27b, it being possible for the said board 30 to include a signal processing circuit for processing the signal emitted by the sensor element 28. The board 30 is connected (not depicted) to a wired connection 31 able to impart information relating to the signals emitted by the sensor element 28 and processed, to an alarm module (not depicted) belonging to the device 1. The alarm module may, for example, be produced in the form of a light and/or audible indicator mounted on the dashboard of the motor vehicle so as to alert the driver to the fact that a belt wear threshold has been reached and that the said belt needs to be replaced.

When mounting the belt tensioner roller device 1 a first step is to set the tension in the belt 9. To do this, the screw 11 is fitted without tightening it so that the adjusting eccentric 2 can turn relative to the engine block 2 and relative to the fixed support 5. Using a spanner collaborating with the ring 19, the adjusting eccentric 2 is pivoted relative to the base plate 17. The roller 8 is thus brought into contact with the belt 9. The adjusting eccentric 2 continues to be turned and this, through reaction between the belt 9 and the roller, causes the working eccentric 3 to rotate relative to the support 5 with an increase in the tension in the spring 6, which exerts a resistive torque between the support 5 and the working eccentric 3, tending permanently to push the roller 8 against the belt 9. The device is designed so that the roller 8 exerts on the belt 9 a force that generates sufficient tension in the said belt 9. The support 5 is then immobilized on the engine block 12 using the screw 11.

When fitting the device 1, an axial end portion 8b of the roller 8 is mounted more or less facing the sensor element 28, the gap between the said roller 8 and the sensor element 28 being small. The sensor element 28 thus detects a first magnetic field created by the magnetic element 29 collaborating magnetically with the roller 8, advantageously made of ferromagnetic material, the axial end portion 8b of the roller 8 being subjected to the field lines of the magnetic element 29.

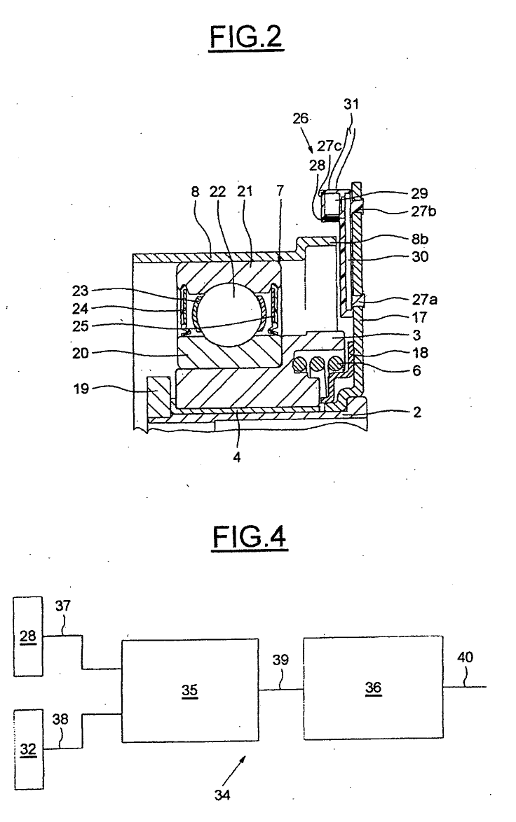

As the belt 9 wears, the working eccentric 3, under the action of the return spring 6, will move angularly relative to the adjusting eccentric 2 and thus pivot thereon. The roller 8, which is mounted on the working eccentric via the rolling bearing 7, will be displaced relative to the fixed support 5 in a path which will tend to modify the gap between the roller 8 and the sensor element 28. The radial gap between the sensor element 28 and the axial end of the roller 8 will thus increase, as illustrated in FIG. 2. Such a variation in the gap thus modifies the magnetic field lines initially established between the magnetic element 29 and the axial end portion 8b of the roller 8, this modification in the field lines being detected via the sensor element 28. In other words, the sensor element 28 detects a second magnetic field different from the first.

The end portion 8b of the roller 8 thus forms a target element magnetically collaborating with the magnetic element 29 to allow critical wear of the said belt to be detected; all that is required is predefining of a gap corresponding to the critical belt wear threshold beyond which modification in the magnetic field detected by the sensor element 28 will be exploited by the board 30 of the device as being a signal corresponding to a predetermined state of belt 9 wear and the signal to be forwarded to the alarm module of the device in order to alert the driver.

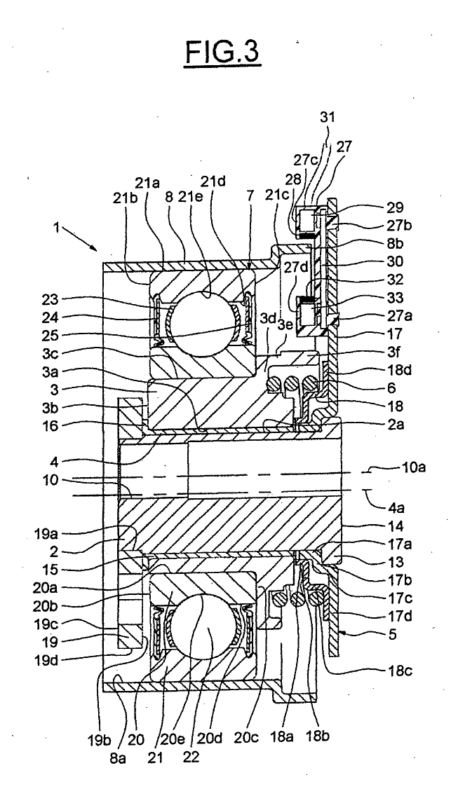

The variant embodiment illustrated in FIG. 3 differs in that the support 27 includes a second axial extension 27d extending axially towards the rolling bearing 7 being positioned radially on the opposite side to the first axial extension 27c when considering the axial end portion 8b of the roller 8.

Similarly, a second sensor element 32 and a second magnetic element 33 are mounted respectively semi-embedded and embedded within the axial extension 27d of the support 27. The sensor element 32, for example a magnetosensitive cell, lies flush with a large-diameter cylindrical surface of the axial extension 27d so as to be mounted facing the axial end of the roller 8, on the inside. The magnetic element 33 is of the same kind as the magnetic element 29 described previously and mounted inside the axial extension 27d so that one of the poles of the magnetic element 33 faces towards the sensor element 32, the other pole facing towards the inside of the device 1.

The use of two sensor elements 28, 32 positioned radially facing the end portion 8b, one on the outside and one on the inside, in particular makes it possible to get around the emergence of parasitic phenomena and improve the resolution of the measurement obtained, for example by taking a differential measurement from the signals delivered by each of the sensor elements 28, 32.

FIG. 4 depicts a block diagram of a processing unit 34 dedicated to the processing of the signals from the sensor elements 28, 32 making it possible in particular to compensate for various variations in external parameters, such as the temperature, the magnetic properties of the material of the roller on its periphery, or even the voltage with which the said sensor elements are powered.

The processing unit 34 includes an analogue/digital converter 35 and a microcontroller 36. Outputs 37, 38 from the sensor elements 28, 32 are connected in parallel to the analogue/digital converter 35, converting the analogue signals supplied by the sensor elements 29, 33 into digital signals. The said signals thus converted are forwarded to the microcontroller 36 via one output 39, the microcontroller 36 being positioned downstream of the analogue/digital converter 35.

The microcontroller 36 is able to exploit the voltages V₁ and V₂ delivered respectively by the sensor elements 28, 32 and to combine the two measurements taken in order to circumvent parasitic phenomena and improve the resolution of the overall measurement forwarded by an output 40 connected to the microcontroller 36. It is possible, for example, to subtract the voltages delivered by the sensor elements 28, 32 (V₁−V₂) or form a ratio between the said voltages (V₁/V₂) or alternatively, to form a ratio between the difference in voltages and the sum of the said voltages (V₁−V₂/V₁+V₂).

The embodiment illustrated in FIG. 5 differs in that the rolling bearing 7 includes, on its exterior cylindrical surface 21a, two annular grooves 41, 42 that are mutually symmetric with respect to a plane passing through the centre of the rolling elements 22 and in that a roller 43 is overmoulded onto the exterior cylindrical surface 21a of the ring 21 of the rolling bearing 7 and includes a stepped bore 43a. The bore here includes two frustoconical portions (unreferenced) which are mutually symmetric with respect to a plane passing through the centre of the rolling elements 22 and forming bearing surfaces for the radial lateral surfaces 21b and 21c.

Here, the roller 43 is made of moulded synthetic material, for example, a glass-fiber-filled nylon-6,6. A target element 44 is mounted embedded within the roller 43. The target element 44, for example a ferromagnetic insert, runs more or less axially between the frustoconical portion bearing against the radial surface 21c of the outer ring 21 and the axial end of the roller 8, on the same side as the support block 27. An axial end of the said insert 44 lies flush with a radial lateral surface of the roller 43. The sensor elements 28 and 32 are thus positioned radially one on each side of the insert 44 forming the target element. The insert 44 thus collaborates magnetically with the magnetic element 29 to detect the tension in the belt 9 via the sensor elements 28 and 32.

Of course, it is equally conceivable to mount the insert 44 semi-embedded within the roller 43 such that the said insert 44 projects from one axial end of the roller 43. It is also conceivable to provide an insert 44 produced in the form of a ferromagnetic ring attached to the axial surface of the roller 43, at the same end as the support block 27.

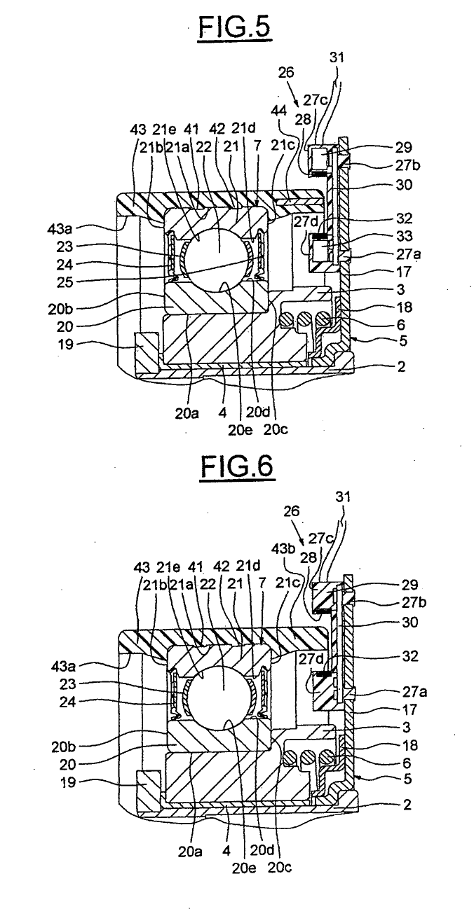

The variant embodiment illustrated in FIG. 6 differs from the preceding embodiment in that the roller 43, made of moulded synthetic material, in this instance is filled with ferrite powder and magnetized at part of an axial end portion 43b of the roller 43 facing the sensor elements 28, 32. The sensor elements 28, 32 of the sensor unit 26 are thus positioned radially one on each side of the magnetized part of the axial end portion 43b.

In this embodiment, the sensor unit has no magnets associated with the sensors 28, 32. It is the roller which emits a magnetic field the magnitude of which is detected by the sensor elements 28, 32 and varies according to the position of the said roller 43 with respect to the fixed support 5 manifested by a modification in the gap between said roller 43 and the sensors 28, 32.

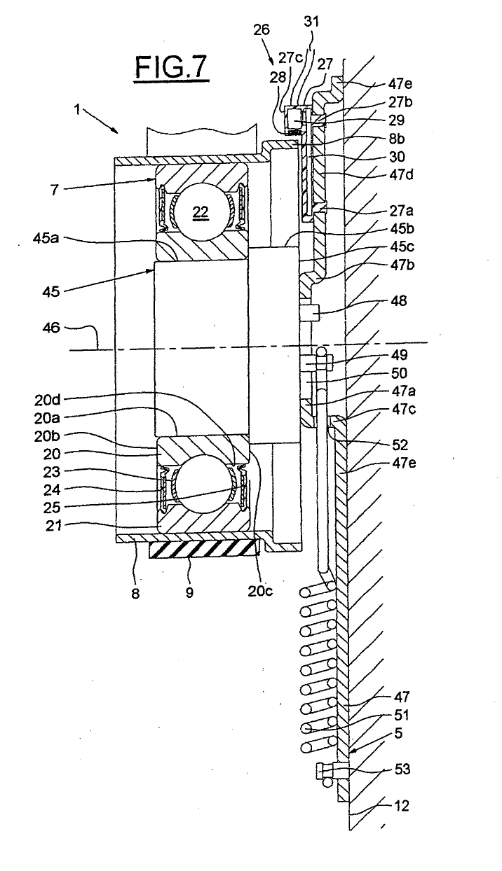

The embodiment illustrated in FIG. 7 differs from the preceding embodiments in that the rolling bearing 7 is fixed to a support hub 45, of axis 46, and in that the fixed support 5 includes a support plate 47 partially in contact with the engine block 12. The hub 45 includes an exterior cylindrical surface 45 extending over the major part of its length and in contact with the bore 20a of the inner ring 20 of the rolling bearing 7. The exterior cylindrical surface 45 is radially extended, on the same side as the engine block 12, by a shoulder 45b forming a bearing face for the radial surface 20c of the inner ring 20 of the rolling bearing 7. The hub 45 includes a lateral radial surface 45c axially on the same side as the shoulder 45, from which guide pins 48, 49 extend axially towards the engine block 12. The substantially cylindrical pins 48, 49 in this instance are each positioned near the geometric axis 46 of the hub 45.

The support plate 47 includes a radial portion 47a in contact with the lateral radial surface 45c of the hub 45 and in which a slot-shaped opening 50 is formed, this slot being radially bounded by two parallel straight edges. The guide pins 48, 49 are positioned to project axially relative to the said opening 50.

The radial portion 47a is extended, on the same side as the engine block 12, by axial protrusions 47b and 47c which are diametrically opposed and of small circumferential size. The axial protrusions 47b and 47c are extended outwards by first and second radial portions 47d and 47e respectively, these being axially offset from one another, the axial portion 47e forming a sole being in contact with the engine block 12. The sensor unit 26 is mounted at the axial portion 47d, the said portion being extended by an axial portion then by the radial portion 47e in contact with the engine block 12.

An actuator, such as a return spring 51, is mounted between the hub 45 and the plate 47 of the fixed support 5 and exerts a return force between the hub 45 and the fixed support 5. The spring 51 extends through a circular opening 52 formed at the axial protrusion 47c of the plate 47. One end of the spring 51 is hooked onto a fixing pin 53 mounted at a free end of the axial lug 47e, the other end of the said spring 51 being hooked onto the guide pin 49 fixed to the hub 45, the said pins 49, 53 being shaped for this purpose.

As the belt 9 wears, the hub 45, the rolling bearing 7 and the roller 8, which form the moving parts, will move linearly relative to the fixed support 5 in a radial direction towards the spring 51, the displacement of the said parts being guided by the pins 48, 49 sliding in the opening 50. The radial gap between the sensor element 28 and the axial end of the roller 8 will thus increase, modifying the magnetic field lines initially established between the magnetic element 29 and the axial end portion 8b of the roller 8.

The device thus makes it possible, during operation, to pick up signals corresponding to the belt tension so as to determine the degree of wear of the said belt in a way that is particularly precise and reliable, making direct use of the displacement of the roller relative to a fixed support of the device.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description to the invention. Changes may be made in the elements described herein without departing from the spirit and scope of the invention as described in the following claims. In addition, it is to be understood that features described herein independently may, in certain embodiments, be combined.

What is claimed is:

1. A belt tensioner roller device provided with a fixed support able to hold the device on an engine block, with moving parts that can move with respect to the fixed support, with a rotary roller supported by the moving parts and intended to be in contact with the belt, and with a component able to exert a permanent force between the fixed support and the moving parts, wherein the rotary roller comprises a target element, the fixed support comprising at least one sensor element mounted facing the target element of the roller with a gap and collaborating with the said target element to detect belt wear as a function of displacement of the rotary roller with respect to the fixed support.

2. The device according to claim 1, wherein the fixed support further comprises at least one magnetic element able to create a magnetic field near the sensor element, the said magnetic element collaborating with the target element of the roller to modify the value of the magnetic field as a function of the displacement of the roller relative to the fixed support.

3. The device according to claim 1, wherein the gap can vary as a function of the displacement of the roller relative to the fixed support.

4. The device according to claim 1, wherein the fixed support comprises two sensor elements positioned radially on either side of the target element of the roller, the sensor elements being electrically connected in such a way as to take a differential measurement of the signals supplied by the sensors.

5. The device according to claim 1, wherein the sensor element detects belt wear as a function of a radial linear displacement of the moving parts with respect to the fixed support.

6. The device according to claim 1, wherein the moving parts comprise a working eccentric that can move angularly relative to the fixed support and supports the roller, the sensor element detecting belt wear as a function of the position of an element supporting the roller relative to the fixed support.

7. The device according to claim 1, wherein the fixed support comprises a plate on which the sensor element is mounted.

8. The device according to claim 1, wherein the target element comprises a ferromagnetic material.

9. The device according to claim 1, wherein an end portion of the roller forms the target element.

10. The device according to claim 1, wherein the target element is attached to or integral with the moving parts.

11. The device according to claim 1, wherein the target element comprises a synthetic material filled with magnetized ferrite powder.

12. The device according to claim 2, further comprising a sensor unit, mounted on the fixed support, and in which the magnetic element is embedded and the sensor element is at least partially housed.

13. The device according to claim 1, wherein the sensor element comprises a linear or digital magnetosensitive cell.

14. A belt tensioner roller device provided with a support able to hold the device on an engine block, with moving parts that can move with respect to the support, with a rotary roller supported by the moving parts and including a belt groove, and with a component able to exert a permanent force between the support and the moving parts, wherein the rotary roller comprises a encoder element, the support comprising at least one sensor element mounted facing the encoder element of the roller with a gap and collaborating with the said encoder element to detect belt wear as a function of displacement of the roller with respect to the support.

15. A method for monitoring belt wear comprising the steps during which a permanent tensile force is exerted between a fixed support and moving parts that can move with respect to the fixed support and that are in contact with the belt, wherein belt wear is detected directly as a function of displacement of the rotary roller relative to the fixed support.
